(19) United States
(12) Patent Application Publication
(10) Pub. No.: US 2025/0330637 A1
(43) Pub. Date: Oct. 23, 2025

(54) IMPROVEMENT OF MOTION VECTOR REDUNDANCY AND SIMILARITY CHECK FOR MERGE MODE

(71) Applicant: Tencent America LLC, Palo Alto, CA (US)

(72) Inventors: Lien-fei CHEN, Palo Alto, CA (US); Xin ZHAO, San Jose, CA (US); Roman CHERNYAK, Santa Clara, CA (US); Xiaozhong XU, State College, PA (US); Shan LIU, San Jose, CA (US)

(73) Assignee: Tencent America LLC, Palo Alto, CA (US)

(21) Appl. No.: 19/260,014

(22) Filed: Jul. 3, 2025

Related U.S. Application Data
(63) Continuation of application No. PCT/US2024/025571, filed on Apr. 19, 2024.
(60) Provisional application No. 63/460,888, filed on Apr. 20, 2023.

(51) Int. Cl. H04N 19/513; H04N 19/105; H04N 19/139; H04N 19/176; H04N 19/577

(52) U.S. Cl. CPC H04N 19/521; H04N 19/105; H04N 19/139; H04N 19/176; H04N 19/577

(57) ABSTRACT

Some aspects of the disclosure provide an apparatus for video decoding. The apparatus includes processing circuitry that is configured to receive a coded video bitstream comprising coded information of one or more pictures, and construct a candidate list for a current block in a current picture, the candidate list comprising at least a first candidate and a second candidate, the first candidate and the second candidate have redundant information of a motion based inheritable parameter and non-redundant information of at least a non-motion based inheritable parameter. The processing circuitry also selects a specific candidate from the candidate list, and reconstructs the current block based on the specific candidate.

### RELATED APPLICATIONS

The present application is a continuation of International Application No. PCT/US2024/025571, entitled “IMPROVEMENT OF MOTION VECTOR REDUNDANCY AND SIMILARITY CHECK FOR MERGE MODE” and filed on Apr. 19, 2024, which claims the benefit of priority to U.S. Provisional Application No. 63/460,888, “IMPROVEMENT OF MOTION VECTOR REDUNDANCY AND SIMILARITY CHECK FOR MERGE MODE” filed on Apr. 20, 2023. The entire disclosures of the prior applications are hereby incorporated by reference.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding. In some examples, an apparatus for video decoding includes processing circuitry.

Some aspects of the disclosure provide a method of processing visual media data. The method includes processing a bitstream of visual media data according to a format rule. The bitstream includes an index pointing to a specific candidate in a candidate list for a prediction of a current block in a current picture. The format rule specifies that a first checking result is obtained by performing a first checking of a motion based inheritable parameter between a potential candidate and a first existing candidate in one or more existing candidates in the candidate list, the first checking result indicating whether the potential candidate has redundant information of the motion based inheritable parameter with the first existing candidate. The format rule also specifies that a second checking result is obtained by performing a second checking of a non-motion based inheritable parameter between the potential candidate and the first existing candidate, the second checking result indicating whether the potential candidate has redundant information of the non-motion based inheritable parameter with the first existing candidate. The format rule also specifies that the potential candidate is redundant to the first existing candidate when the first checking result indicates that the potential candidate has the redundant information of the motion based inheritable parameter with the first existing candidate and the second checking result indicates that the potential candidate has the redundant information of the non-motion based inheritable parameter with the first existing candidate.

In some examples, the motion based inheritable parameter includes a motion vector (MV) when the current block is in an inter prediction mode, and the non-motion based inheritable parameter comprises a bi-prediction with coding unit level weights (BCW) index.

In some examples, the motion based inheritable parameter includes a block vector (BV) when the current block is in an intra block copy (IBC) mode, and the non-motion based inheritable parameter comprises a reconstruction reordered type of IBC for the IBC mode.

Some aspects of the disclosure provide a method of video encoding. The method includes determining to construct a candidate list for a prediction of a current block in a current picture, determining a potential candidate for adding into the candidate list, the candidate list including one or more existing candidates that has been added into the candidate list, and performing a first checking of a motion based inheritable parameter between the potential candidate and a first existing candidate in the one or more existing candidates to obtain a first checking result. The first checking result indicates whether the potential candidate has redundant information of the motion based inheritable parameter with the first existing candidate. The method also includes performing at least a second checking of a non-motion based inheritable parameter between the potential candidate and the first existing candidate to obtain a second checking result, the second checking result indicates whether the potential candidate has redundant information of the non-motion based inheritable parameter with the first existing candidate. The method also includes determining that the potential candidate is redundant to the first existing candidate when the first checking result indicates that the potential candidate has the redundant information of the motion based inheritable parameter with the first existing candidate and the second checking result indicates that the potential candidate has the redundant information of the non-motion based inheritable parameter with the first existing candidate.

In some examples, the motion based inheritable parameter comprises a motion vector (MV) when the current block is in an inter prediction mode. In an example, the non-motion based inheritable parameter comprises a bi-prediction with coding unit level weights (BCW) index.

In some examples, the motion based inheritable parameter comprises a block vector (BV) when the current block is in an intra block copy (IBC) mode. In an example, the non-motion based inheritable parameter comprises a reconstruction reordered type of IBC for the IBC mode. For example, the non-motion based inheritable parameter includes one of a vertical flip and a horizontal flip.

In some examples, the second checking result indicates whether the non-motion based inheritable parameter of the potential candidate is exactly same as the first existing candidate.

In some examples, the second checking result indicates whether a difference of the non-motion based inheritable parameter between the potential candidate and the first existing candidate is within a range.

Some aspects of the disclosure provide an apparatus for video decoding. The apparatus includes processing circuitry that is configured to receive a coded video bitstream comprising coded information of one or more pictures, and construct a candidate list for a current block in a current picture, the candidate list comprising at least a first candidate and a second candidate, the first candidate and the second candidate have redundant information of a motion based inheritable parameter and non-redundant information of at least a non-motion based inheritable parameter. The processing circuitry also selects a specific candidate from the candidate list, and reconstructs the current block based on the specific candidate.

In some examples, the processing circuitry determines a potential candidate for adding into the candidate list and performs a first checking of the motion based inheritable parameter between the potential candidate and the first candidate that is an existing candidate in the candidate list to obtain a first checking result, the first checking result indicates whether the potential candidate has redundant information of the motion based inheritable parameter as the first candidate.

In some examples, the processing circuitry performs at least a second checking of the non-motion based inheritable parameter between the potential candidate and the first candidate to obtain a second checking result, the second checking result indicates whether the potential candidate has redundant information of the non-motion based inheritable parameter as the first candidate. The processing circuitry determines that the potential candidate is redundant to the first candidate when the first checking result indicates that the potential candidate has the redundant information of the motion based inheritable parameter as the first candidate and the second checking result indicates that the potential candidate has the redundant information of the non-motion based inheritable parameter as the first candidate.

In some examples, the motion based inheritable parameter comprises a motion vector (MV) when the current block is in an inter prediction mode. In an example, the non-motion based inheritable parameter comprises a bi-prediction with coding unit level weights (BCW) index.

In some examples, the motion based inheritable parameter comprises a block vector (BV) when the current block is in an intra block copy (IBC) mode. The non-motion based inheritable parameter comprises a reconstruction reordered type of IBC for the IBC mode. For example, the non-motion based inheritable parameter comprises at least one of a vertical flip and a horizontal flip.

In some examples, the processing circuitry determines that the potential candidate has the redundant information of the non-motion based inheritable parameter as the first candidate when the non-motion based inheritable parameter of the potential candidate is exactly same as the first candidate.

In some examples, the processing circuitry determines that the potential candidate has the redundant information of the non-motion based inheritable parameter as the first candidate when a difference of the non-motion based inheritable parameter between the potential candidate and the first candidate is within a range.

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system (100).

FIG. 2 is a schematic illustration of an exemplary block diagram of a decoder.

FIG. 3 is a schematic illustration of an exemplary block diagram of an encoder.

FIG. 4 shows positions of spatial merge candidates according to an embodiment of the disclosure.

FIG. 5 shows candidate pairs that are considered for a redundancy check of spatial merge candidates according to an embodiment of the disclosure.

FIG. 6 shows motion vector scaling for a temporal merge candidate in some examples.

FIG. 7 shows candidate positions for a temporal merge candidate of a current block in some examples.

FIG. 8 shows an example of template matching.

FIG. 9 shows a diagram of spatial merge candidates of a current block in some examples.

FIG. 10 shows a diagram of template and reference samples of the template for block with sub-block motion using the motion information of the subblocks of the current block in some examples.

FIG. 11 shows a diagram for an adaptive reordering of merge candidate (ARMC) reordering process in some examples.

FIGS. 12A and 12B show diagrams of block vector adjustment in some examples

FIG. 13 shows a flow chart outlining an encoding process according to some embodiments of the disclosure.

FIG. 14 shows a flow chart outlining a decoding process according to some embodiments of the disclosure.

FIG. 15 is a schematic illustration of a computer system in accordance with an embodiment.

### DETAILED DESCRIPTION OF EMBODIMENTS

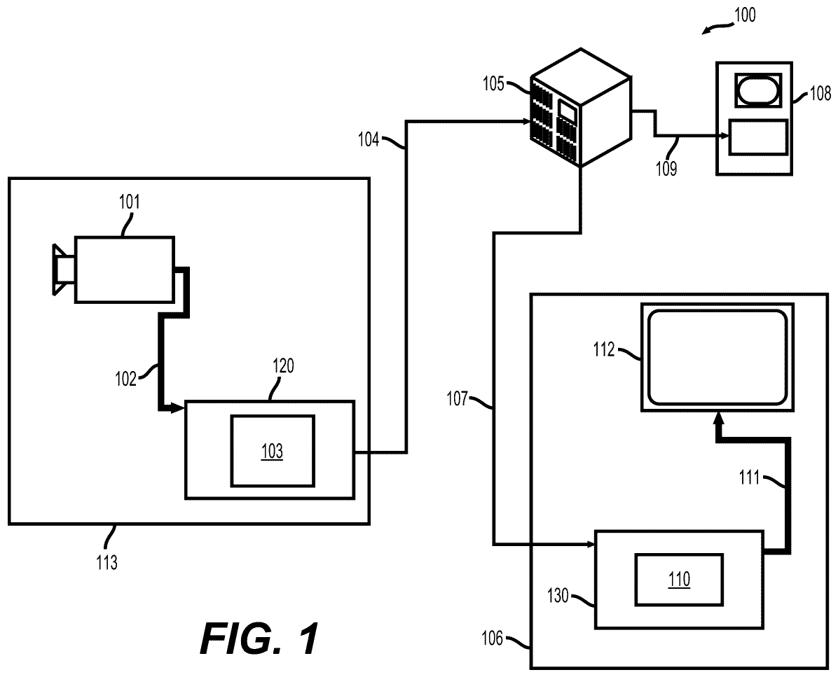

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

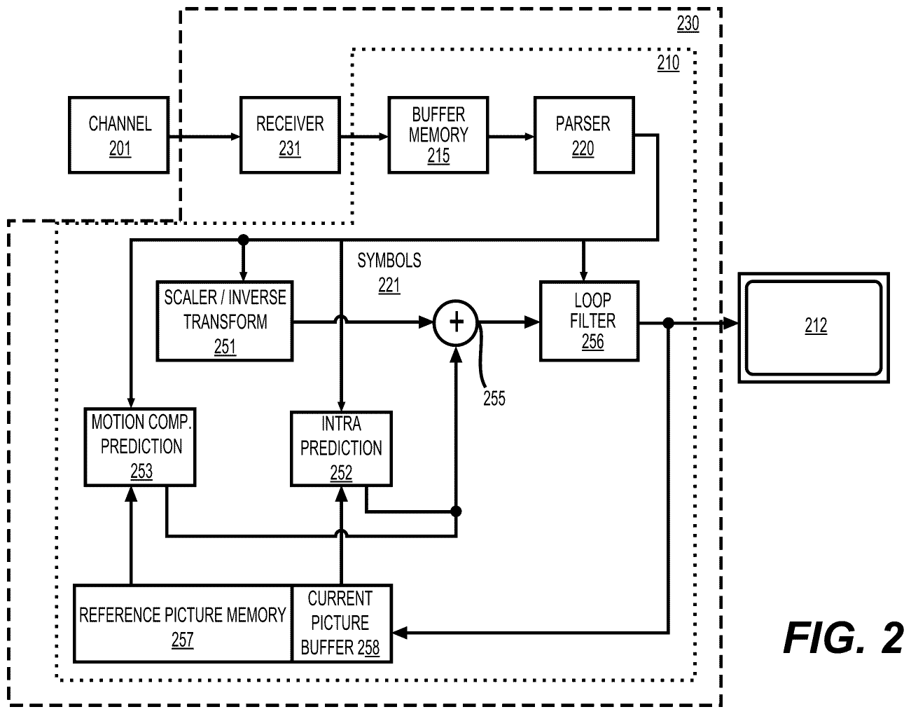

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

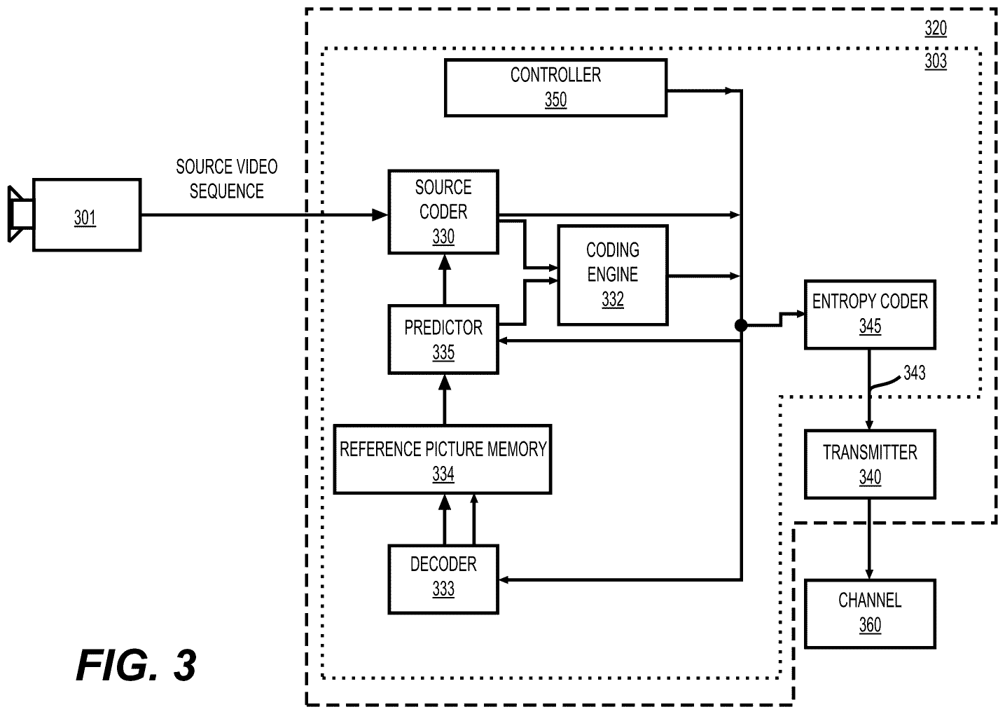

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

Various inter prediction modes can be used in video coding. For example, in VVC, for an inter-predicted CU, motion parameters can include MV(s), one or more reference picture indices, a reference picture list usage index, and additional information for certain coding features to be used for inter-predicted sample generation. A motion parameter can be signaled explicitly or implicitly. When a CU is coded with a skip mode, the CU can be associated with a PU and can have no significant residual coefficients, no coded motion vector delta or MV difference (e.g., MVD) or a reference picture index. A merge mode can be specified where the motion parameters for the current CU are obtained from neighboring CU(s), including spatial and/or temporal candidates, and optionally additional information such as introduced in VVC. The merge mode can be applied to an inter-predicted CU, not only for skip mode. In an example, an alternative to the merge mode is the explicit transmission of motion parameters, where MV(s), a corresponding reference picture index for each reference picture list and a reference picture list usage flag and other information are signaled explicitly per CU.

In an embodiment, such as in VVC, VVC Test model (VTM) reference software includes one or more refined inter prediction coding tools that include: an extended merge prediction, a merge motion vector difference (MMVD) mode, an adaptive motion vector prediction (AMVP) mode with symmetric MVD signaling, an affine motion compensated prediction, a subblock-based temporal motion vector prediction (SbTMVP), an adaptive motion vector resolution (AMVR), a motion field storage ( 1/16th luma sample MV storage and 8×8 motion field compression), a bi-prediction with CU-level weights (BCW), a bi-directional optical flow (BDOF), a prediction refinement using optical flow (PROF), a decoder side motion vector refinement (DMVR), a combined inter and intra prediction (CIIP), a geometric partitioning mode (GPM), and the like. Inter predictions and related methods are described in details below.

Extended merge prediction can be used in some examples. In an example, such as in VTM4, a merge candidate list is constructed by including the following five types of candidates in order: spatial motion vector predictor(s) (MVP(s)) from spatial neighboring CU(s), temporal MVP(s) from collocated CU(s), history-based MVP(s) (HMVP(s)) from a first-in-first-out (FIFO) table, pairwise average MVP(s), and zero MV(s).

A size of the merge candidate list can be signaled in a slice header. In an example, the maximum allowed size of the merge candidate list is 6 in VTM4. For each CU coded in the merge mode, an index (e.g., a merge index) of a best merge candidate can be encoded using truncated unary binarization (TU). The first bin of the merge index can be coded with context (e.g., context-adaptive binary arithmetic coding (CABAC)) and a bypass coding can be used for other bins.

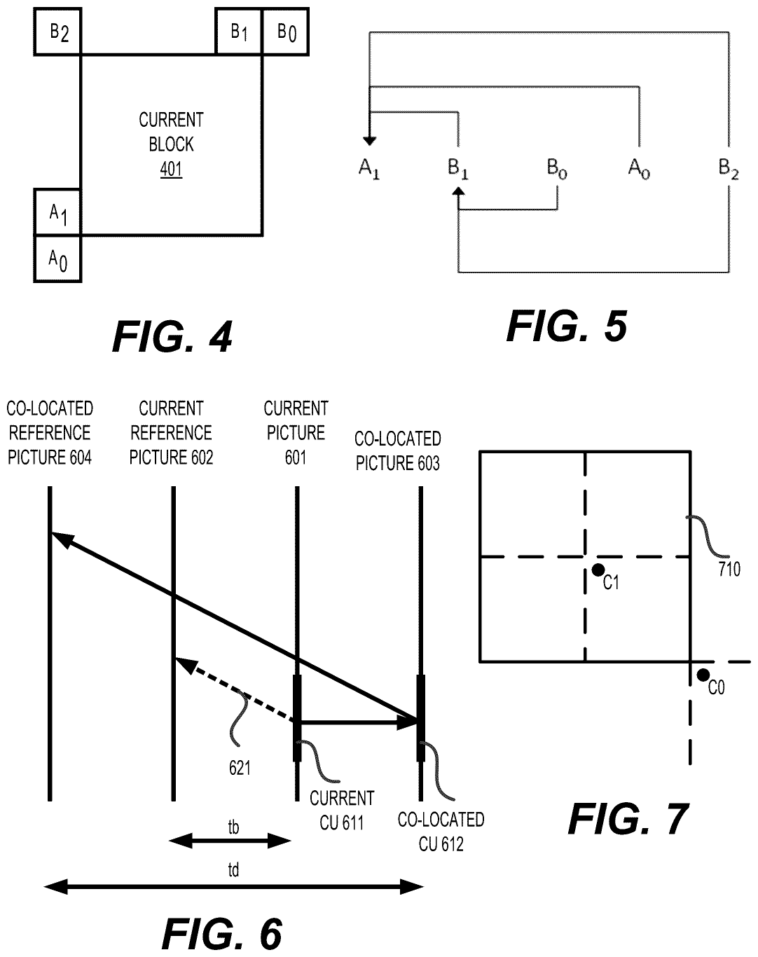

Some examples of a generation process of each category of merge candidates are provided below. In an embodiment, spatial candidate(s) are derived as follows. The derivation of spatial merge candidates in VVC can be identical to that in HEVC. In an example, a maximum of four merge candidates are selected among candidates located in positions depicted in FIG. 4.

FIG. 4 shows positions of spatial merge candidates according to an embodiment of the disclosure. Referring to FIG. 4, an order of derivation is B1, A1, B0, A0, and B2. The position B2 is considered only when any CU of positions A0, B0, B1, and A1 is not available (e.g., because the CU belongs to another slice or another tile) or is intra coded. After a candidate at the position A1 is added, the addition of the remaining candidates is subject to a redundancy check which ensures that candidates with same motion information are excluded from the candidate list so that coding efficiency is improved.

To reduce computational complexity, not all possible candidate pairs are considered in the mentioned redundancy check. Instead, only pairs linked with an arrow in FIG. 5 are considered and a candidate is only added to the candidate list if the corresponding candidate used for the redundancy check does not have the same motion information.

FIG. 5 shows candidate pairs that are considered for a redundancy check of spatial merge candidates according to an embodiment of the disclosure. Referring to FIG. 5, the pairs linked with respective arrows include A1 and B1, A1 and A0, A1 and B2, B1 and B0, and B1 and B2. Thus, candidates at the positions B1, A0, and/or B2 can be compared with the candidate at the position A1, and candidates at the positions B0 and/or B2 can be compared with the candidate at the position B1.

In an embodiment, temporal candidate(s) are derived as follows. In an example, only one temporal merge candidate is added to the candidate list. FIG. 6 shows motion vector scaling for a temporal merge candidate in some examples. To derive the temporal merge candidate of a current CU (611) in a current picture (601), a scaled MV (621) (e.g., shown by a dotted line in FIG. 6) can be derived based on a co-located CU (612) belonging to a collocated reference picture (604). A reference picture list used to derive the co-located CU (612) can be explicitly signaled in a slice header. The scaled MV (621) for the temporal merge candidate can be obtained as shown by the dotted line in FIG. 6. The scaled MV (621) can be scaled from the MV of the co-located CU (612) using picture order count (POC) distances tb and td. The POC distance tb can be defined to be the POC difference between a current reference picture (602) of the current picture (601) and the current picture (601). The POC distance td can be defined to be the POC difference between the collocated reference picture (604) of the co-located picture (603) and the co-located picture (603). A reference picture index of the temporal merge candidate can be set to zero. The collocated picture is a reference picture that is used as the source picture for temporal motion information derivation. The collocated picture can be identified in one of two lists, referred to as list0 or list1. In some examples, the encoder can determine the collocated picture and signal the collocated picture using suitable syntax techniques.

FIG. 7 shows candidate positions (e.g., C0 and C1) for a temporal merge candidate of a current CU in some examples. A position for the temporal merge candidate can be selected from the candidate positions C0 and C1. The candidate position C0 is located at a bottom-right corner of a co-located CU (710) of the current CU. The candidate position C1 is located at a center of the co-located CU (710) of the current CU. If a CU at the candidate position C0 is not available, is intra coded, or is outside of a current row of CTUs, the candidate position C1 is used to derive the temporal merge candidate. Otherwise, for example, the CU at the candidate position C0 is available, inter coded, and in the current row of CTUs, the candidate position C0 is used to derive the temporal merge candidate. A temporal merge candidate can specify the motion information of a temporal motion vector predictor (TMVP).

Some additional compression tools beyond VVC can further improve the compression efficiency of VVC standard.

In some examples, template matching (TM) technique that refines motion at the decoder side can be used in video/image coding (e.g., VVC, ECM and the like) to further improve the compression efficiency. In the TM mode, an MV can be refined by constructing a template (e.g., a current template) of a block (e.g., a current block) in a current picture and determine the closest matching between the template of the block in the current picture and a plurality of possible templates (e.g., a plurality of possible reference templates) in a reference picture. In an embodiment, the template of the block in the current picture can include left neighboring reconstructed samples of the block and above neighboring reconstructed samples of the block.

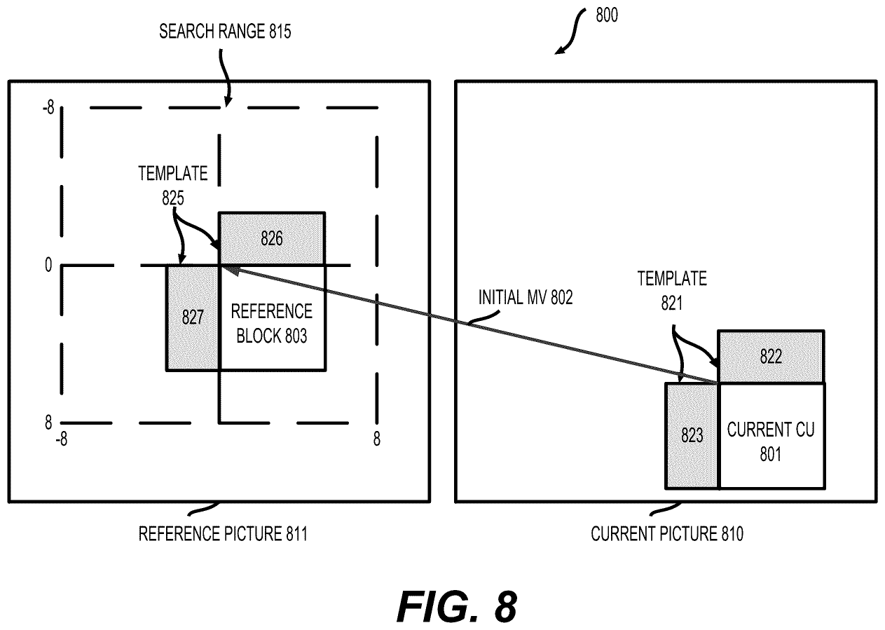

FIG. 8 shows an example of template matching (800). The TM can be used to derive motion information (e.g., deriving final motion information from initial motion information, such as an initial MV 802) of a current CU (e.g., a current block) (801) by determining the closest match between a template (e.g., a current template) (821) of the current CU (801) in a current picture (810) and a template (e.g., a reference template) of a plurality of possible templates (e.g., one of the plurality of possible templates being a template (825)) in a reference picture (811). The template (821) of the current CU (801) can have any suitable shape and any suitable size.

In an embodiment, the template (821) of the current CU (801) includes a top template (822) and a left template (823). Each of the top template (822) and the left template (823) can have any suitable shape and any suitable size.

The top template (822) can include samples in one or more top neighboring blocks of the current CU (801). In an example, the top template (822) includes one or more rows of samples above the current CU (801). The left template (823) can include samples in one or more left neighboring blocks of the current CU (801). In an example, the left template (823) includes one or more columns of samples left to the current CU (801).

Each one (e.g., the template (825)) of the plurality of possible templates in the reference picture (811) corresponds to the template (821) in the current picture (810). In an embodiment, the initial MV (802) points from the current CU (801) to a reference block (803) in the reference picture (811). Each one (e.g., the template (825)) of the plurality of possible templates in the reference picture (811) and the template (821) in the current picture (810) can have an identical shape and an identical size. For example, the template (825) of the reference block (803) includes a top template (826) in the reference picture (811) and a left template (827) in the reference picture (811). The top template (826) can include samples above the reference block (803). The left template (827) can include samples left to the reference block (803).

A TM cost can be determined based on a pair of templates, such as the template (e.g., the current template) (821) and the template (e.g., the reference template) (825). The TM cost can indicate matching between the template (821) and the template (825). An optimized MV (or a final MV) can be determined based on a search around the initial MV (802) of the current CU (801) within a search range (815). The search range (815) can have any suitable shape and any suitable number of reference samples. In an example, the search range (815) in the reference picture (811) includes a [−L, L]-pel range where L is a positive integer, such as 8 (e.g., 8 samples). For example, a difference (e.g., [0, 1]) is determined based on the search range (815), and an intermediate MV is determined by a summation of the initial MV (802) and the difference (e.g., [0, 1]). An intermediate reference block and a corresponding template in the reference picture (811) can be determined based on the intermediate MV. A TM cost can be determined based on the template (821) and the intermediate template in the reference picture (811). The TM costs can correspond to the differences (e.g., [0, 0] corresponding to the initial MV (802), [0, 1], and the like) that are determined based on the search range (815). In an example, the difference corresponding to the smallest TM cost is selected, and the optimized MV is the summation of the difference corresponding to the smallest TM cost and the initial MV (802). As described above, the TM can derive the final motion information (e.g., the optimized MV) from the initial motion information (e.g., the initial MV 802).

In the FIG. 8 example, a better MV can be searched around the initial motion vector of the current CU within a search range, such as [−8pel, +8pel]. In some examples (e.g., ECM), the template matching is also adopted with several modifications. In an example, search step size is determined by AMVR mode. In another example, TM can be cascaded with bilateral matching process. In another example, the template-matching is also used to reorder index of candidates in the merge candidate list and AMVP candidate list.

In some examples, a merge candidate list can include one or more non-adjacent spatial merge candidates. In an example, the non-adjacent spatial merge candidates are inserted behind the TMVP in a merge candidate list.

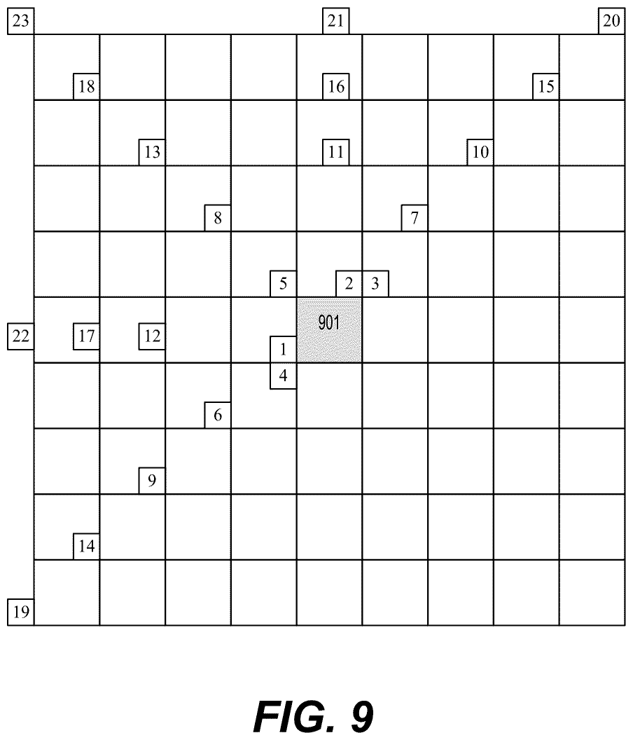

FIG. 9 shows a diagram of spatial merge candidates of a current block (901) in some examples. In the FIG. 9 example, locations 1-5 are adjacent spatial merge candidate positions for the current block (901) (also referred to as current coding block), and the locations 6-23 can be locations of non-adjacent spatial merge candidates for the current block (901). For example, the motion information at one or more of the locations 6-23 can be inserted into a merge candidate list as one or more non-adjacent spatial merge candidates. In some examples, the distances between the non-adjacent spatial candidates and current coding block (901) are based on the width and height of the current block (current coding block) (901).

In some examples, techniques that are referred to as adaptive reordering of merge candidates with template matching can be used. In an example, a candidate list, such as a regular merge candidate list, a template matching (TM) merge candidate list, a bilateral matching (BM) merge candidate list, and the like, is constructed by adding candidates into the candidate list in an order. For example, candidates can be added in an order of spatial MVP (SMVP) from spatial adjacent neighboring CUs (e.g., adjacent spatial merge candidates at one or more locations 1-5 in FIG. 9), temporal MVP (TMVP) from collocated CUs (e.g., temporal MVP at C0 or C1 in FIG. 7), non-adjacent MVP (NA-MVP) from spatially non-adjacent CUs (e.g., one or more non-adjacent spatial merge candidates at locations 6-23 in FIG. 9), history-based MVP (HMVP) from a FIFO table, pairwise average MVP (PAMVP) and zero MVs.

In some examples, candidates in the candidate list are reordered according to the techniques of the adaptive reordering of merge candidates with template matching (ARMC) method. The ARMC can reorder the MV candidates in the candidate list based on the TM cost. In an example, the candidate list, which can include various candidate types, such as TMVP type, NA-SMVP type and the like, are reordered by using the TM cost in ascending order. In another example, a specific type of candidates in the candidate list, such as the TMVP type or the NA-SMVP type, can be reordered by using the TM cost in ascending order. The reordering method can be applied not only to the regular merge mode and template matching (TM) merge mode, but also to affine merge mode (excluding the SbTMVP candidate). In an example, for the TM merge mode, merge candidates are reordered before the refinement process.

In some examples, after a merge candidate list is constructed, merge candidates in the merge candidate list are divided into several subgroups. For example, the subgroup size is set to 5. Then, merge candidates in each subgroup are reordered ascendingly according to cost values based on template matching. For simplification, in an example, merge candidates in the last but not the first subgroup are not reordered.

In some examples, for subblock-based merge candidates with subblock size equal to Wsub×Hsub, the above template includes several sub-templates with the size of Wsub×1, and the left template includes several sub-templates with the size of 1×Hsub.

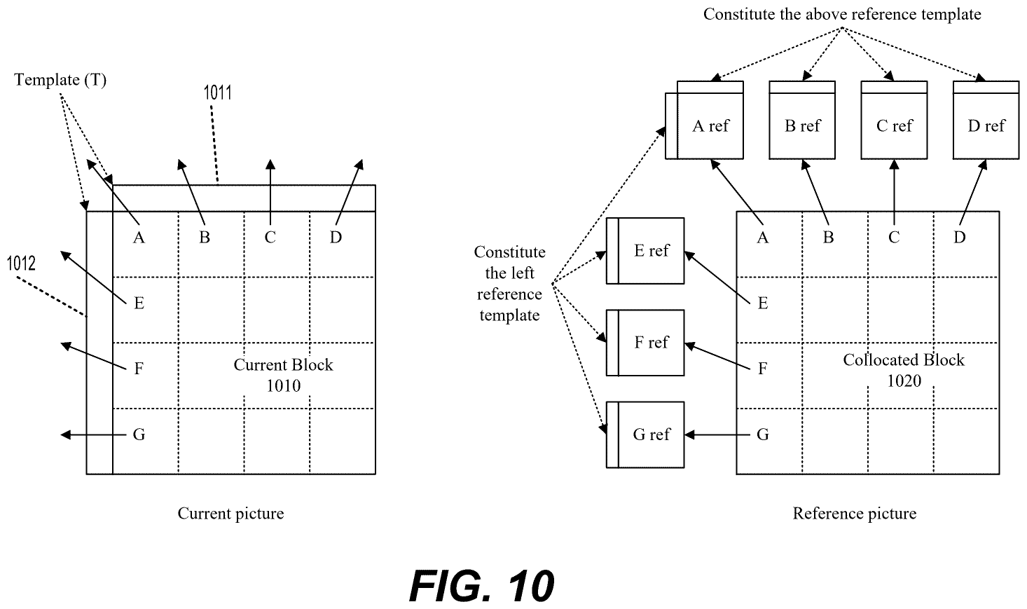

FIG. 10 shows a diagram of template and reference samples of the template for block with sub-block motion using the motion information of the subblocks of the current block in some examples. The motion information of the subblocks in the first row and the first column of current block is used to derive the reference samples of each sub-template.

In the FIG. 10 example, the template (T) of a current block (1010) includes a row (1011) above the current block (1010) and a column (1012) left of the current block (1010). The row (1011) is also referred to as above template, and the column (1012) is also referred to as left template. The current block (1010) includes a plurality of subblocks, such as 16 subblocks in FIG. 10 example. Subblocks in the first row of the current block (1010) are shown as A, B, C and D, and subblocks in the first column of the current block (1010) are shown as A, E, F, and G.

In the FIG. 10 example, a reference picture includes a collocated block (1020) for the current block (1010). The motion information of the subblocks A, B, C, D, E, F and G can be used to derive reference subblocks in the reference picture, such as shown by A ref, B ref, C ref, D ref, E ref, Fref and G ref in FIG. 10. The above sub-templates of the A ref, B ref, C ref and D ref can constitute the above reference template for the above template (1011), and the left sub-template of the A ref, E ref, Fref and G ref can constitute the left reference template for the left template (1012).

In some examples, in order to improve the coding efficiency, the MV candidates reordering is not only applied to a single TMVP type or a single NA-MVP type, but also applied to the hybrid candidate types including NA-MVP, HMVP, and PAMVP types. In some examples, the merge candidate list includes several duplicate zero MV candidates. According to an aspect of the disclosure, the several duplicate zero MV candidates, such as the motion vector is (0, 0) for all available reference list, may be sorted to the early position in the candidate list. In some examples, all zero MV candidates are excluded from the ARMC reordering process. After the ARMC reordering, the duplicate Zero MVs are filled at the end of the merge candidate list, thus the zero MV candidates stay at the later positions in the candidate list.

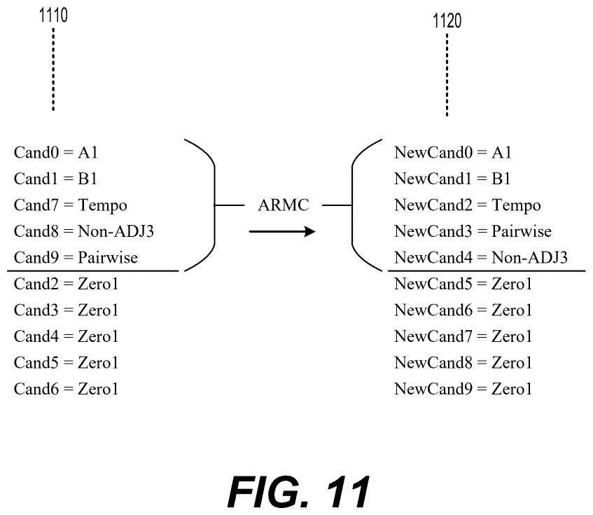

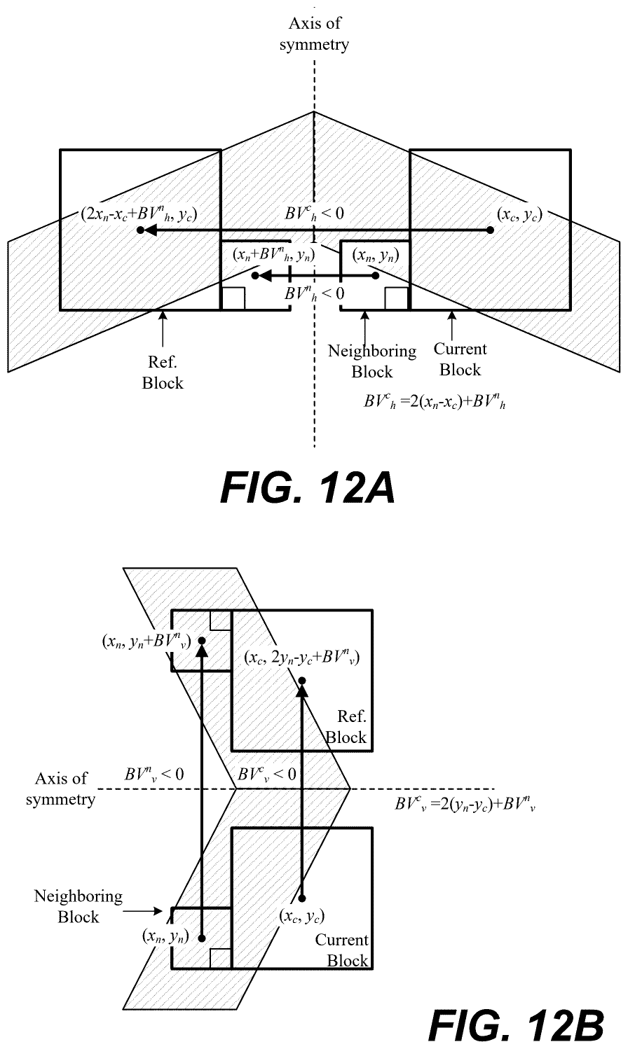

FIG. 11 shows a diagram for an ARMC reordering process in some examples. In the FIG. 11 example, all zero MV candidates are excluded from the ARMC reordering process. For example, a candidate list (1110) before the ARMC reordering includes candidates in an order of Cand0, Cand1, Cand2, Cand3, Cand4, Cand5, Cand6, Cand7, Cand8, and Cand9. The candidates Cand2 to Cand6 are zero MV candidates, and are excluded from the ARMC reordering. The ARMC reordering is performed on Cand0, Cand1, Cand7, Cand8, and Cand9 to obtain the first 5 candidates in the reordered candidate list (1120), such as shown by NewCand0, NewCand1, NewCand2, NewCand3 and NewCand4. Then, the zero MV candidates are filled at the end of the reordered candidate list (1120), such as shown by NewCand5, NewCand6, NewCand7, NewCand8 and NewCand9.

It is noted that block based compensation can be used for inter prediction and intra prediction. For the inter prediction, block based compensation from a different picture is known as motion compensation. Block based compensation can also be done from a previously reconstructed area within the same picture, such as in intra prediction. The block based compensation from reconstructed area within the same picture is referred to as intra picture block compensation, current picture referencing (CPR), or intra block copy (IBC). A displacement vector that indicates an offset between a current block and a reference block (also referred to as a prediction block) in the same picture is referred to as a block vector (BV) where the current block can be encoded/decoded based on the reference block. Different from a motion vector in motion compensation, which can be at any value (positive or negative, at either x or y direction), a BV has a few constraints to ensure that the reference block is available and already reconstructed. Also, in some examples, for parallel processing consideration, some reference area that is tile boundary, slice boundary, or wavefront ladder shape boundary is excluded.

In some examples, IBC mode can be used to significantly improve the coding efficiency of screen content materials. Generally, IBC mode can be implemented as a block level coding mode. At the encoder side, the encoder can perform block matching (BM) to find the optimal block vector for each CU. In some examples, at the encoder side, a hash-based motion estimation (also referred to as hash based search) is performed for a CU in the IBC mode. The encoder can perform rate distortion (RD) check for blocks with either width or height no larger than 16 luma samples. For non-merge mode, the block vector search is performed using hash-based search first. If hash search does not return valid candidate, block matching based local search can be performed.

In some examples, in the hash-based search, hash key matching (32-bit CRC) between the current block and a reference block is extended to all allowed block sizes in the current picture. The hash key calculation for every position in the current picture can be based on 4×4 subblocks. For the current block of a larger size, a hash key can be determined to match that of the reference block when all the hash keys of all 4×4 subblocks match the hash keys in the corresponding reference locations. If hash keys of multiple reference blocks are found to match that of the current block, the block vector costs of each of the matched reference blocks can be calculated and the one matched reference block with the minimum cost is then selected as the result of the hash-based search.

In some examples, the block matching search searches a region that is local to the current block. For example, in the block matching search, the search range is set to cover both the previous and current CTUs.

The coding of a block vector could be either explicit or implicit. In the explicit mode, a BV difference between a block vector and its predictor is signaled. In the implicit mode, the block vector is recovered from a predictor (referred to as block vector predictor) without using the BV difference, in a similar way as a motion vector in the merge mode. The explicit mode can be referred to as a non-merge BV prediction mode, or IBC AMVP mode in some examples. The implicit mode can be referred to as a merge BV prediction mode, IBC merge mode, IBC skip mode in some examples.

There can be variations for the IBC mode. In an example, the IBC mode is treated as a third mode that is different from the intra prediction mode and the inter prediction mode. Accordingly, the BV prediction in the implicit mode (or the IBC merge mode) and the explicit mode (IBC AMVP mode) are separated from the regular inter mode. In some examples a separate merge candidate list can be defined for the IBC mode where entries in the separate merge candidate list are BVs. Similarly, in an example, a BV prediction candidate list in the IBC explicit mode (IBC AMVP mode) only includes BVs. General rules applied to the two lists (i.e., the separate merge candidate list for IBC merge mode and the BV prediction candidate list for the IBC AMVP mode) are that the two lists may follow the same logic as a merge candidate list used in the regular merge mode (used in inter prediction) or an advanced motion vector prediction (AMVP) predictor list used in the regular AMVP mode (used in inter prediction) in terms of the candidate derivation process. For example, the five spatial neighboring locations (e.g., A0, A1, and B0, B1, B2 in FIG. 2), for example, HEVC or VVC inter merge mode are accessed for the IBC merge mode to derive the separate merge candidate list for the IBC merge mode.

In an implementation example, for a CU, a block level flag is used to signal whether IBC AMVP mode or IBC skip/merge mode is used. In an example, when a flag (e.g., denoted merge_flag) is true, IBC skip/merge mode is used; and when the flag is false, IBC AMVP mode is used.

In some examples, for the IBC skip/merge mode, a merge candidate index can be signaled to indicate which of the block vectors in the merge candidate list from neighboring candidate IBC coded blocks is used as the BV predictor to predict the current block. The merge candidate list can include spatial, history-based motion vector prediction (HMVP), and pairwise candidates in some examples.

In some examples, a technique that is referred to as reconstruction-reordered IBC (RR-IBC) or RR-IBC mode is allowed for IBC coded blocks. When RR-IBC is applied, the samples in a reconstruction block are flipped according to a flip type of the current block. In an example, at the encoder side, the original block is flipped before motion search and residual calculation, while the prediction block is derived without flipping. At the decoder side, the reconstruction block is flipped back to restore the original block. The flip type can be horizontal flip or vertical flip in some examples.

In some examples, to better utilize the symmetry property, a flip-aware block vector (BV) adjustment approach is applied to refine the block vector candidate.

FIGS. 12A and 12B show diagrams of BV adjustment in some examples.

In FIGS. 12A and 12B, (xₙ, yₙ) represent the coordinates of the center sample of the neighboring block, and (x_{c}, y_{c}) represent the coordinates of the center sample of the current block, respectively. BVⁿ denotes the BV of the neighboring block and BV^{c} denotes the BV of the current block.

In the example of FIG. 12A, the neighboring block is coded with a horizontal flip, instead of directly inheriting the BV from a neighboring block, the horizontal component (denoted by BV^{c}ₕ) of BV^{c} is calculated by adding a motion shift to the horizontal component (denoted as BVⁿₕ) of BVⁿ since the neighboring block is coded with the horizontal flip. For example, the calculation can be represented by BV^{c}ₕ=2 (xₙ−x_{c})+BVⁿₕ.

In the example of FIG. 12B, the neighboring block is coded with vertical flip. The vertical component (denoted by BV^{c}ᵥ) of BV^{c} is calculated by adding a motion shift to the vertical component (BVⁿᵥ) of BVⁿ since the neighboring block is coded with the vertical flip. For example, the calculation can be represented by BV^{c}ᵥ=2 (yₙ−y_{c})+BVⁿᵥ.

In some examples, before adding a potential candidate to a merge candidate list, a redundancy check or similarity check, such as using ‘mvdSimilarityThresh’ are applied to determine whether the potential candidate has same or similar motion information as an existing candidate in the merge candidate list. A potential candidate with the same or similar motion information as an existing candidate can be excluded from the merge candidate list.

In some examples, the current block inherits additional information other than the motion information from a candidate in a candidate list. The information other than the motion information that can be passed from a candidate in the candidate list to the current block is referred to as other inherited information. For example, local illumination compensation (LIC) flag can be passed from a candidate in a candidate list to the current block, and LIC flag can be included as a condition in the redundancy and similarity check, LIC flag is other inherited information in an example.

In some examples, the inherited information refers to a portion of the information of a candidate (for a current block) that is passed to the current block when the candidate is selected for a prediction of the current block, thus the current block inherits the portion of the information of the candidate. In some examples, the inherited information is also referred to as inheritable parameters, and includes motion based inheritable parameter(s) and non-motion based inheritable parameter(s). In some examples, the motion based inheritable parameters include motion vector, reference list, reference index, block vector and the like; the non-motion based inheritable parameters can include, BCW index, interpolation filter selection, LIC flag, and the like.

Some aspects of the disclosure provide techniques for the redundancy and similarity check. In some examples, the redundancy and similarity check can include a condition check of other inherited information (e.g., non-motion based inheritable parameters) of the current coded block (e.g., a potential candidate) and each of the existing candidates in a candidate list. For example, to determine whether a potential candidate is redundant and should not be included in the candidate list, not only the similarity of MV(s) between the potential candidate and an existing candidate in the candidate list is examined, but also the similarity of the other inherited information (e.g., non-motion based inheritable parameters) between the potential candidate and the existing candidate in the candidate list is examined. In some examples, a potential candidate will not be filled into the candidate list when both of above two checking (1. similarity of MV and 2. similarity of the other inherited information (e.g., non-motion based inheritable parameters) return true (e.g., both the MV and the other inherited information of the potential candidate are similar to an existing candidate in the candidate list). In an example, when a potential candidate has the same MV as an existing candidate but has different other inherited information from the existing candidate, the potential candidate still can be added into the candidate list.

For example, encoder/decoder can construct a candidate list for a current block in a current picture, the candidate list includes at least a first candidate and a second candidate, the first candidate and the second candidate have redundant information of a motion based inheritable parameter and non-redundant information of at least a non-motion based inheritable parameter.

In some embodiments, the inherited information includes the BCW index for a regular merge candidate list construction.

In some examples, bi-prediction with CU-level weight (BCW) can be used to weight predictions from different reference pictures differently. The BCW technology is designed to predict a block by weighted-averaging two motion-compensated prediction blocks. BCW is different from a technique that is referred to as weighting prediction (WP) which indicates weights at slice level. BCW can signal the weight information at CU level by using an index, denoted as bcwIdx. The index can point to a selected weight from a list of pre-defined candidate weights. In some examples, the list includes 5 candidate weights that are pre-defined, such as {−2, 3, 4, 5, 10}/8, to be selected for reference pictures in reference list 1 (also referred to as reference picture list 1), where −2/8 and 10/8 can be used to reduce negatively correlated noises between prediction blocks of bi-prediction. The list of the pre-defined candidate weights may be reduced to {3, 4, 5}/8 when the forward and backward reference pictures in both reference lists are used to achieve better trade-off between performance and complexity. In some examples, since unit-gain constraint is applied, once the weight, denoted as w pointed to by bcwIdx, corresponding to reference list 1 is determined, the weight corresponding to the other reference list can be calculated by 1−w. In an example, each luma/chroma prediction sample of BCW is computed as Eq. (1):

$${P}_{BCW} = ( 8 ( 1 - w ) \times {P}_{0} + 8 w \times {P}_{1} + 4 ) ≫ 3 \qquad Eq . ( 1 )$$

where P_{BCW} is the final prediction of a current-block sample (a sample in the current block) and P₀ and P₁ are prediction samples pointed to by the motion vectors respectively from reference picture in list 0 (also referred to as reference picture list 0) and reference picture in list 1 (also referred to as reference picture list 1). In some examples, BCW is enabled only for bi-predicted CUs with at least 256 luma samples and WP being turned off. The BCW is also extended to affine AMVP modes.

In some examples, the use of bcwIdx can be buffered for subsequent CUs in the same frame to perform spatial motion merging, either for regular or for affine merge mode. In an example, when a spatial neighboring merge candidate is bi-predicted and the current CU selects this candidate (the spatial neighboring merge candidate), all the reference indices and motion vectors (or control point motion vectors (CPMV) in the case of inherited affine merge mode) including its bcwIdx are inherited by the current CU. In some examples, the only exception that the bcwIdx is not inherited occurs when the current CU has CIIP flag enabled. In the case of constructed affine merge mode, the bcwIdx is inherited from the one associated with above-left control-point motion vectors (or above-right control-point motion vectors when above-left ones are not used). It is noted that when the inferred bcwIdx points to a non-0.5 weight, decoder-side motion vector refinement (DMVR) and bidirectional optical flow (BDOF) are both turned off.

In some examples, the BCW index is in the inherited information, and the similarity and redundancy check includes a condition of BCW index. Specifically, when a first checking of motion information between a potential candidate and an existing candidate in the candidate list returns true (e.g., the potential candidate with has the same MV as the existing candidate), but a second checking of BCW index between the potential candidate and the existing candidate returns false (e.g., the BCW index of the potential candidate is not the same as the existing candidate), the potential candidate is not considered as redundant as the existing candidate. When the potential candidate is not redundant to any existing candidate in the candidate list, the potential candidate can be suitably inserted into the candidate list in an example.

In some embodiments, the inherited information includes the reconstruction reordered type (e.g., the flip type) of IBC for IBC merge candidate list construction. In some examples, the similarity and redundancy check includes a condition of the reconstruction reordered type. Specifically, when a first checking of motion information between a potential candidate and an existing candidate in the candidate list returns true (e.g., the potential candidate with has the same MV as the existing candidate), but a second checking of the reconstruction reordered type between the potential candidate and the existing candidate returns false (e.g., one of the potential candidate and the existing candidate has vertical flip and the other one has horizontal flip), the potential candidate is not considered as redundant as the existing candidate. When the potential candidate is not redundant to any existing candidate in the candidate list, the potential candidate can be suitably inserted into the candidate list in an example.

In some embodiments, for the above second checking (the similarity of other inherited information between the potential candidate and existing candidates), only when the inherited information between the potential candidate and existing candidates is exactly the same, it is determined that the second checking returns true. In an example, when the inherited information includes the BCW index and the BCW index of the potential candidate is exactly the same as an existing candidate, then the second checking returns true.

In some embodiments, for the above second checking (the similarity of other inherited information between the potential candidate and existing candidates), only when the difference of the inherited information between the potential candidate and existing candidates is within a threshold, it is determined that the second checking returns true. In an example, when the inherited information includes the BCW index and the difference of the BCW index between the potential candidate and an existing candidate is within a range, such as [−1,1], then the second checking returns true.

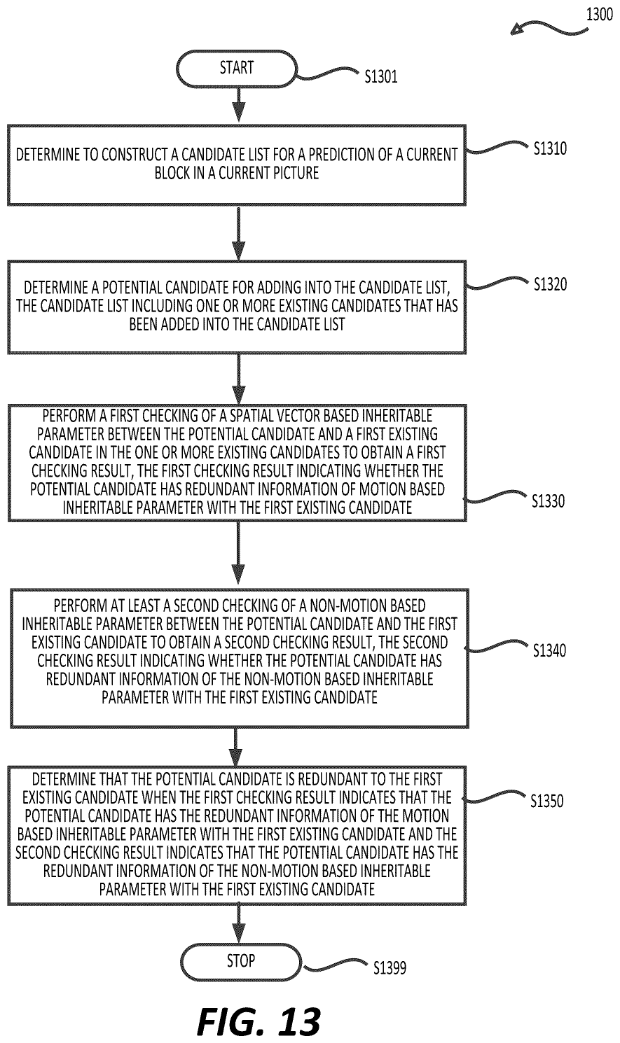

FIG. 13 shows a flow chart outlining a process (1300) according to an embodiment of the disclosure. The process (1300) can be used in a video encoder. In various embodiments, the process (1300) is executed by processing circuitry, such as the processing circuitry that performs functions of the video encoder (103), the processing circuitry that performs functions of the video encoder (303), and the like. In some embodiments, the process (1300) is implemented in software instructions, thus when the processing circuitry executes the software instructions, the processing circuitry performs the process (1300). The process starts at (S1301) and proceeds to (S1310).

At (S1310), to construct a candidate list for a prediction of a current block in a current picture is determined.

At (S1320), a potential candidate is determined for adding into the candidate list, the candidate list includes one or more existing candidates that has been added into the candidate list.

At (S1330), a first checking of a motion based inheritable parameter between the potential candidate and a first existing candidate in the one or more existing candidates is performed to obtain a first checking result, the first checking result indicates whether the potential candidate has redundant information of the motion based inheritable parameter with the first existing candidate.

At (S1340), a second checking of a non-motion based inheritable parameter between the potential candidate and the first existing candidate is performed to obtain a second checking result, the second checking result indicates whether the potential candidate has redundant information of the non-motion based inheritable parameter with the first existing candidate.

At (S1350), the potential candidate is determined to be redundant to the first existing candidate when the first checking result indicates that the potential candidate has the redundant information of the motion based inheritable parameter with the first existing candidate and the second checking result indicates that the potential candidate has the redundant information of the non-motion based inheritable parameter with the first existing candidate.

In some examples, the motion based inheritable parameter includes a motion vector (MV) when the current block is in an inter prediction mode. The non-motion based inheritable parameter includes a bi-prediction with coding unit level weights (BCW) index.

In some examples, the motion based inheritable parameter includes a block vector (BV) when the current block is in an intra block copy (IBC) mode. The non-motion based inheritable parameter includes a reconstruction reordered type of IBC for the IBC mode. In an example, the non-motion based inheritable parameter includes one of a vertical flip and a horizontal flip.

In some examples, the second checking result indicates whether the non-motion based inheritable parameter of the potential candidate is exactly same as the first existing candidate.

In some examples, the second checking result indicates whether a difference of the non-motion based inheritable parameter between the potential candidate and the first existing candidate is within a range.

Then, the process proceeds to (S1399) and terminates.

The process (1300) can be suitably adapted. Step(s) in the process (1300) can be modified and/or omitted. Additional step(s) can be added. Any suitable order of implementation can be used.

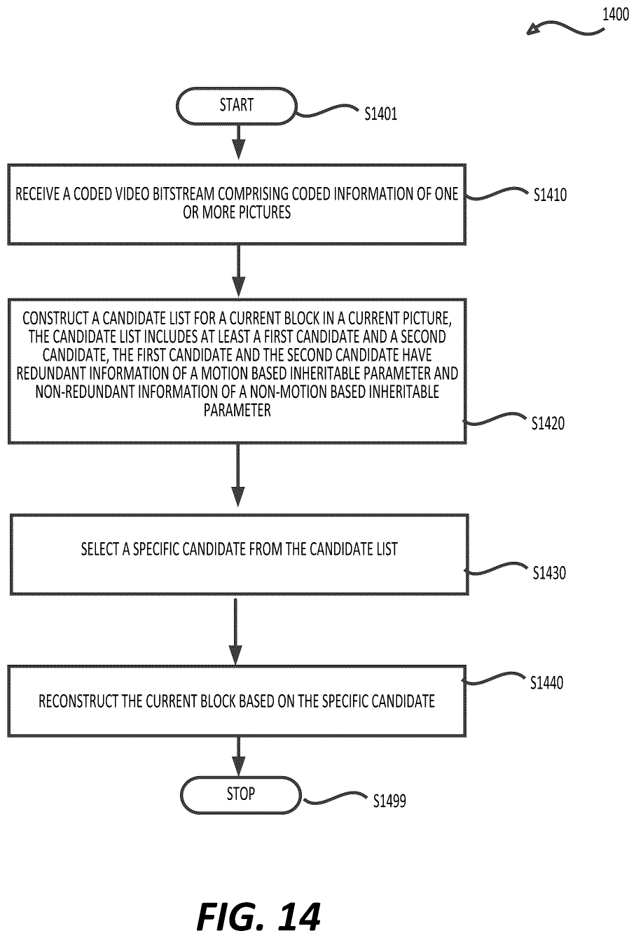

FIG. 14 shows a flow chart outlining a process (1400) according to an embodiment of the disclosure. The process (1400) can be used in a video decoder. In various embodiments, the process (1400) is executed by processing circuitry, such as the processing circuitry that performs functions of the video decoder (110), the processing circuitry that performs functions of the video decoder (210), and the like. In some embodiments, the process (1400) is implemented in software instructions, thus when the processing circuitry executes the software instructions, the processing circuitry performs the process (1400). The process starts at (S1401) and proceeds to (S1410).

At (S1410), a coded video bitstream including coded information of one or more pictures is received.

At (S1420), a candidate list for a current block in a current picture is constructed, the candidate list includes at least a first candidate and a second candidate, the first candidate and the second candidate have redundant information of a motion based inheritable parameter and non-redundant information of a non-motion based inheritable parameter.

At (S1430), a specific candidate is selected from the candidate list.

At (S1440), the current block is reconstructed based on the specific candidate.

In some examples, a potential candidate for adding into the candidate list is determined. A first checking of the motion based inheritable parameter between the potential candidate and the first candidate that is an existing candidate in the candidate list is performed to obtain a first checking result, the first checking result indicates whether the potential candidate has redundant information of the motion based inheritable parameter as the first candidate. At least a second checking of the non-motion based inheritable parameter between the potential candidate and the first candidate is performed to obtain a second checking result, the second checking result indicates whether the potential candidate has redundant information of the non-motion based inheritable parameter as the first candidate. The potential candidate is determined to be redundant to the first candidate when the first checking result indicates that the potential candidate has the redundant information of the motion based inheritable parameter as the first candidate and the second checking result indicates that the potential candidate has the redundant information of the non-motion based inheritable parameter as the first candidate.

In some examples, the motion based inheritable parameter includes a motion vector (MV) when the current block is in an inter prediction mode. The non-motion based inheritable parameter includes a bi-prediction with coding unit level weights (BCW) index.

The motion based inheritable parameter includes a block vector (BV) when the current block is in an intra block copy (IBC) mode. The non-motion based inheritable parameter includes a reconstruction reordered type of IBC for the IBC mode. In an example, the non-motion based inheritable parameter comprises at least one of a vertical flip and a horizontal flip.

In some examples, the potential candidate is determined to have the redundant information of the non-motion based inheritable parameter as the first candidate when the non-motion based inheritable parameter of the potential candidate is exactly same as the first candidate.

In some examples, the potential candidate is determined to have the redundant information of the non-motion based inheritable parameter as the first candidate when a difference of the non-motion based inheritable parameter between the potential candidate and the first candidate is within a range.

Then, the process proceeds to (S1499) and terminates.

The process (1400) can be suitably adapted. Step(s) in the process (1400) can be modified and/or omitted. Additional step(s) can be added. Any suitable order of implementation can be used.

According to an aspect of the disclosure, a method of processing visual media data is provided. In the method, a bitstream of visual media data is processed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes an index pointing to a specific candidate in a candidate list for a prediction of a current block in the current picture. The format rule specifies that a first checking result is obtained by performing a first checking of a motion based inheritable parameter between a potential candidate and a first existing candidate in one or more existing candidates in the candidate list, the first checking result indicating whether the potential candidate has redundant information of the motion based inheritable parameter with the first existing candidate, a second checking result is obtained by performing a second checking of a non-motion based inheritable parameter between the potential candidate and the first existing candidate, the second checking result indicating whether the potential candidate has redundant information of the non-motion based inheritable parameter with the first existing candidate, and the potential candidate is redundant to the first existing candidate when the first checking result indicates that the potential candidate has the redundant information of the motion based inheritable parameter with the first existing candidate and the second checking result indicates that the potential candidate has the redundant information of the non-motion based inheritable parameter with the first existing candidate.

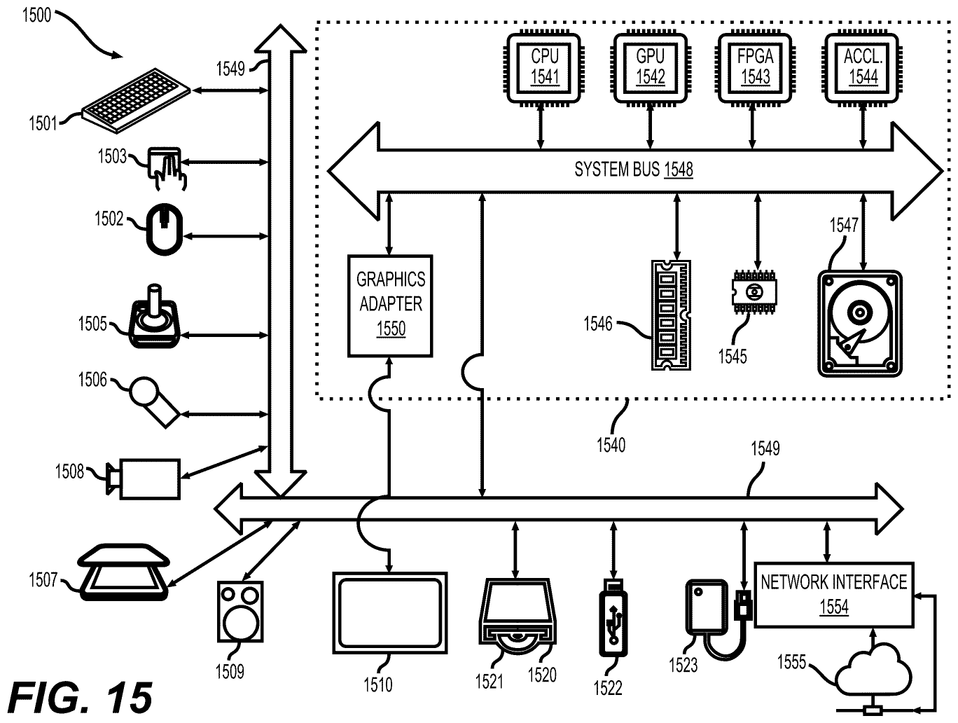

The techniques described above, can be implemented as computer software using computer-readable instructions and physically stored in one or more computer-readable media. For example, FIG. 15 shows a computer system (1500) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 15 for computer system (1500) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1500).

Computer system (1500) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1501), mouse (1502), trackpad (1503), touch screen (1510), data-glove (not shown), joystick (1505), microphone (1506), scanner (1507), camera (1508).

Computer system (1500) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1510), data-glove (not shown), or joystick (1505), but there can also be tactile feedback devices that do not serve as input devices), audio output devices (such as: speakers (1509), headphones (not depicted)), visual output devices (such as screens (1510) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1500) can also include human accessible storage devices and their associated media such as optical media including CD/DVD ROM/RW (1520) with CD/DVD or the like media (1521), thumb-drive (1522), removable hard drive or solid state drive (1523), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1500) can also include an interface (1554) to one or more communication networks (1555). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1549) (such as, for example USB ports of the computer system (1500)); others are commonly integrated into the core of the computer system (1500) by attachment to a system bus as described below (for example Ethernet interface into a PC computer system or cellular network interface into a smartphone computer system). Using any of these networks, computer system (1500) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1540) of the computer system (1500).

The core (1540) can include one or more Central Processing Units (CPU) (1541), Graphics Processing Units (GPU) (1542), specialized programmable processing units in the form of Field Programmable Gate Areas (FPGA) (1543), hardware accelerators for certain tasks (1544), graphics adapters (1550), and so forth. These devices, along with Read-only memory (ROM) (1545), Random-access memory (1546), internal mass storage such as internal non-user accessible hard drives, SSDs, and the like (1547), may be connected through a system bus (1548). In some computer systems, the system bus (1548) can be accessible in the form of one or more physical plugs to enable extensions by additional CPUs, GPU, and the like. The peripheral devices can be attached either directly to the core's system bus (1548), or through a peripheral bus (1549). In an example, the screen (1510) can be connected to the graphics adapter (1550). Architectures for a peripheral bus include PCI, USB, and the like.

CPUs (1541), GPUs (1542), FPGAs (1543), and accelerators (1544) can execute certain instructions that, in combination, can make up the aforementioned computer code. That computer code can be stored in ROM (1545) or RAM (1546). Transitional data can also be stored in RAM (1546), whereas permanent data can be stored for example, in the internal mass storage (1547). Fast storage and retrieve to any of the memory devices can be enabled through the use of cache memory, that can be closely associated with one or more CPU (1541), GPU (1542), mass storage (1547), ROM (1545), RAM (1546), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1500), and specifically the core (1540) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1540) that are of non-transitory nature, such as core-internal mass storage (1547) or ROM (1545). The software implementing various embodiments of the present disclosure can be stored in such devices and executed by core (1540). A computer-readable medium can include one or more memory devices or chips, according to particular needs. The software can cause the core (1540) and specifically the processors therein (including CPU, GPU, FPGA, and the like) to execute particular processes or particular parts of particular processes described herein, including defining data structures stored in RAM (1546) and modifying such data structures according to the processes defined by the software. In addition or as an alternative, the computer system can provide functionality as a result of logic hardwired or otherwise embodied in a circuit (for example: accelerator (1544)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding, comprising:
receiving a coded video bitstream comprising coded information of one or more pictures;
constructing a candidate list for a current block in a current picture, the candidate list comprising at least a first candidate and a second candidate, the first candidate and the second candidate having redundant information of a motion based inheritable parameter and non-redundant information of a non-motion based inheritable parameter;
selecting a specific candidate from the candidate list; and
reconstructing the current block based on the specific candidate.

2. The method of claim 1, wherein the constructing comprises:
determining a potential candidate for adding into the candidate list;
performing a first checking of the motion based inheritable parameter between the potential candidate and the first candidate that is an existing candidate in the candidate list to obtain a first checking result, the first checking result indicating whether the potential candidate has redundant information of the motion based inheritable parameter as the first candidate;
performing at least a second checking of the non-motion based inheritable parameter between the potential candidate and the first candidate to obtain a second checking result, the second checking result indicating whether the potential candidate has redundant information of the non-motion based inheritable parameter as the first candidate; and
determining that the potential candidate is redundant to the first candidate when the first checking result indicates that the potential candidate has the redundant information of the motion based inheritable parameter as the first candidate and the second checking result indicates that the potential candidate has the redundant information of the non-motion based inheritable parameter as the first candidate.

3. The method of claim 2, wherein the motion based inheritable parameter comprises a motion vector (MV) when the current block is in an inter prediction mode.

4. The method of claim 3, wherein the non-motion based inheritable parameter comprises a bi-prediction with coding unit level weights (BCW) index.

5. The method of claim 2, wherein the motion based inheritable parameter comprises a block vector (BV) when the current block is in an intra block copy (IBC) mode.

6. The method of claim 5, wherein the non-motion based inheritable parameter comprises a reconstruction reordered type of IBC for the IBC mode.

7. The method of claim 6, wherein the non-motion based inheritable parameter comprises at least one of a vertical flip and a horizontal flip.

8. The method of claim 2, wherein the constructing comprises:
determining that the potential candidate has the redundant information of the non-motion based inheritable parameter as the first candidate when the non-motion based inheritable parameter of the potential candidate is exactly same as the first candidate.

9. The method of claim 2, wherein the constructing comprises:
determining that the potential candidate has the redundant information of the non-motion based inheritable parameter as the first candidate when a difference of the non-motion based inheritable parameter between the potential candidate and the first candidate is within a range.

10. A method of video encoding, comprising:
determining to construct a candidate list for a prediction of a current block in a current picture;
constructing the candidate list for the current block in the current picture, the candidate list comprising at least a first candidate and a second candidate, the first candidate and the second candidate having redundant information of a motion based inheritable parameter and non-redundant information of a non-motion based inheritable parameter;
selecting a specific candidate from the candidate list; and
encoding the current block based on the specific candidate.

11. The method of claim 10, wherein the constructing comprises:
determining a potential candidate for adding into the candidate list;
performing a first checking of the motion based inheritable parameter between the potential candidate and the first candidate that is an existing candidate in the candidate list to obtain a first checking result, the first checking result indicating whether the potential candidate has redundant information of the motion based inheritable parameter as the first candidate;
performing at least a second checking of the non-motion based inheritable parameter between the potential candidate and the first candidate to obtain a second checking result, the second checking result indicating whether the potential candidate has redundant information of the non-motion based inheritable parameter as the first candidate; and
determining that the potential candidate is redundant to the first candidate when the first checking result indicates that the potential candidate has the redundant information of the motion based inheritable parameter as the first candidate and the second checking result indicates that the potential candidate has the redundant information of the non-motion based inheritable parameter as the first candidate.

12. The method of claim 11, wherein the motion based inheritable parameter comprises a motion vector (MV) when the current block is in an inter prediction mode.

13. The method of claim 12, wherein the non-motion based inheritable parameter comprises a bi-prediction with coding unit level weights (BCW) index.

14. The method of claim 11, wherein the motion based inheritable parameter comprises a block vector (BV) when the current block is in an intra block copy (IBC) mode.

15. The method of claim 14, wherein the non-motion based inheritable parameter comprises a reconstruction reordered type of IBC for the IBC mode.

16. The method of claim 15, wherein the non-motion based inheritable parameter comprises at least one of a vertical flip and a horizontal flip.

17. The method of claim 11, further comprising:
determining that the potential candidate has the redundant information of the non-motion based inheritable parameter as the first candidate when the non-motion based inheritable parameter of the potential candidate is exactly same as the first candidate.

18. The method of claim 11, further comprising:
determining that the potential candidate has the redundant information of the non-motion based inheritable parameter as the first candidate when a difference of the non-motion based inheritable parameter between the potential candidate and the first candidate is within a range.

19. A non-transitory computer readable medium storing a video media bitstream that is encoded by an encoding method, the encoding method comprising:
determining to construct a candidate list for a prediction of a current block in a current picture;
constructing the candidate list for the current block in the current picture, the candidate list comprising at least a first candidate and a second candidate, the first candidate and the second candidate having redundant information of a motion based inheritable parameter and non-redundant information of a non-motion based inheritable parameter;
selecting a specific candidate from the candidate list;
encoding the current block into encoded information of the current block based on the specific candidate; and
transmitting the video media bitstream that includes the encoded information of the current block.

20. The non-transitory computer readable medium of claim 19, wherein the encoding method comprises:
determining a potential candidate for adding into the candidate list;
performing a first checking of the motion based inheritable parameter between the potential candidate and the first candidate that is an existing candidate in the candidate list to obtain a first checking result, the first checking result indicating whether the potential candidate has redundant information of the motion based inheritable parameter as the first candidate;
performing at least a second checking of the non-motion based inheritable parameter between the potential candidate and the first candidate to obtain a second checking result, the second checking result indicating whether the potential candidate has redundant information of the non-motion based inheritable parameter as the first candidate; and
determining that the potential candidate is redundant to the first candidate when the first checking result indicates that the potential candidate has the redundant information of the motion based inheritable parameter as the first candidate and the second checking result indicates that the potential candidate has the redundant information of the non-motion based inheritable parameter as the first candidate.
